(19) United States
(12) Patent Application Publication
(10) Pub. No.: US 2015/0177555 A1
(43) Pub. Date: Jun. 25, 2015

(54) DISPLAY APPARATUS

(71) Applicant: FUNAI ELECTRIC CO., LTD., Osaka (JP)

(72) Inventors: Akihiro FUJIKAWA, Osaka (JP); Tatsuji SUDO, Hirakata-shi (JP)

(21) Appl. No.: 14/573,505

(22) Filed: Dec. 17, 2014

(30) Foreign Application Priority Data
Dec. 25, 2013 (JP) 2013-267629

(51) Int. Cl. G02F 1/1333

(52) U.S. Cl. CPC G02F 1/133308; G02F 2001/133311; G02F 2001/133317

(57) ABSTRACT

A display apparatus including: a liquid crystal panel that displays an image; a front cabinet that covers a periphery of a front surface of the liquid crystal panel; a rear cabinet that covers a rear surface of the liquid crystal panel and is connected to the front cabinet at a mating surface; and a rib disposed in a space between the mating surface and a periphery of the liquid crystal panel and extending from the front cabinet toward the rear cabinet.

### CROSS REFERENCE TO RELATED APPLICATION

The present application is based on and claims priority of Japanese Patent Application No. 2013-267629 filed on Dec. 25, 2013. The entire disclosure of the above-identified application, including the specification, drawings and claims is incorporated herein by reference in its entirety.

### FIELD

The present invention relates to display apparatuses for displaying images.

### BACKGROUND

Conventional display apparatuses include those for displaying images, such as liquid crystal television receivers (for example, see Patent Literature (PTL) 1). FIG. 6 is a cross sectional view of relevant components of a conventional display apparatus. As illustrated in FIG. 6, a casing 102 of a display apparatus 100 includes a resin front cabinet 104 and a resin rear cabinet 106 interconnected together. The front cabinet 104 covers the periphery of the front surface of a liquid crystal panel 108 (display panel) disposed in the casing 102. The rear cabinet 106 covers the entire rear surface of the liquid crystal panel 108.

A bezel 110, a molded frame 112, and a rear frame 114 are also disposed in the casing 102 in addition to the liquid crystal panel 108. The bezel 110 is a metal frame-like component for supporting the periphery of the front surface of the liquid crystal panel 108. The molded frame 112 is a resin frame-like component for supporting the periphery of the rear surface of the liquid crystal panel 108, The rear frame 114 is a metal frame for supporting a backlight (not shown in the drawings), and is disposed between the liquid crystal panel 108 and the rear cabinet 106.

The bezel 110 is fixed to the molded frame 112 and the rear frame 114 by a metal screw 116. With this, the bezel 110 is electrically connected to the rear frame 114 via the screw 116, Note that the rear frame 114 is, for example, fastened to a ground wire of a wiring substrate (not shown in the drawings) with a screw (not shown in the drawings) to establish a conductive connection (ground) between the rear frame 114 and the ground wire of the wiring substrate.

With the display apparatus 100 configured in this manner, there is a slight gap at a mating surface 118 between the front cabinet 104 and the rear cabinet 106. Consequently, static electricity may travel through this gap into the interior of casing 102, as indicated by the arrow in FIG. 6. In such a case, adverse effect of static electricity on the liquid crystal panel 108 is minimized since the static electricity in the interior of casing 102 is grounded after flowing through the bezel 110, the screw 116, and the rear frame 114,

### CITATION LIST

### Patent Literature

[PTL 1] Japanese Unexamined Patent Application Publication No. 2007-94224

### SUMMARY

### Technical Problem

Recent years have seen an increase in demand for reduction in the size of the portion of the perimeter of the liquid crystal panel 108 that does not contribute to image display (in other words, the edge portion). Methods of reducing the size of the edge portion include, for example, omitting the bezel 110 from the components of the display apparatus 100 described above. However, when the bezel 110 is omitted, static electricity that enters the interior of casing 102 cannot be grounded and may adversely affect the liquid crystal panel 108,

The present invention aims to solve the above-described problem by providing a display apparatus capable of protecting the display panel from static electricity.

### Solution to Problem

In order to achieve the above-described goal, a display apparatus for displaying an image includes: a display panel that displays the image; a front casing that covers a periphery of a front surface of the display panel; a rear casing that covers a rear surface of the display panel and is connected to the front casing at a mating surface; and a rib disposed in a space between the mating surface and a periphery of the display panel and extending from the front casing toward the rear casing.

With this configuration, since the front casing includes a rib disposed in the space between (i) the mating surface between the front casing and the rear casing and (ii) the periphery of the display panel, the creepage distance from the mating surface to the periphery of the display panel can be increased. Consequently, even when, for example, the bezel described in the Background section of the present disclosure is omitted, it is possible to minimize the occurrence of static electricity that enters the interior of the display apparatus jumping to the display panel and protect the display panel from static electricity. Furthermore, providing the front casing with the rib increases the rigidity of the front casing.

For example, with the display apparatus according to an aspect of the present invention, the rib may be provided along an entire perimeter of the front casing.

With this configuration, since the rib is provided along the entire perimeter of the front casing, it is possible to minimize the occurrence of static electricity that enters the interior of the display apparatus jumping to the display panel even more effectively.

For example, with the display apparatus according to an aspect of the present invention, the rib may extend beyond the mating surface.

With this configuration, since the rib extends beyond the mating surface between the front casing and the rear casing, the creepage distance from the mating surface to the periphery of the display panel can be increased even further.

For example, the display apparatus according to an aspect of the present invention may further include: a support member that supports a periphery of the rear surface of the display panel; and a rear member made of metal and disposed between the display panel and the rear casing, wherein the support member may have an opening that exposes a surface of the rear member to a distal end of the rib.

With this configuration, the support member has an opening that exposes the surface of the rear member to the distal end of the rib. Consequently, static electricity that enters the interior of the display apparatus is grounded after flowing from the distal end of the rib to the surface of the rear member through the opening of the support member. As a result, it is possible to minimize the occurrence of static electricity that enters the interior of the display apparatus jumping to the display panel even more effectively.

For example, the display apparatus according to an aspect of the present invention may further include a flexible wiring substrate disposed on the periphery of the display panel, wherein the opening is arranged corresponding to the flexible wiring substrate.

With this configuration, the opening is arranged corresponding to the flexible wiring substrate. Consequently, static electricity that enters the interior of the display apparatus does not jump to the free end of the flexible wiring substrate, but rather is grounded after flowing from the distal end of the rib to the surface of the rear member through the opening of the support member. As a result, it is possible to minimize the occurrence of static electricity that enters the interior of the display apparatus jumping to the flexible wiring substrate.

For example, with the display apparatus according to an aspect of the present invention, the rib may extend from a base surface of the front casing toward the rear casing, and a distance from the base surface to the distal end of the rib may be greater than a distance from the base surface to a free end of the flexible wiring substrate, and a distance from the distal end of the rib to the free end of the flexible wiring substrate may be greater than a distance from the distal end of the rib to the rear member.

With this configuration, the creepage distance from the mating surface between the front casing and the rear casing to the surface of the rear member can be made to be shorter than the creepage distance from the mating surface to the free end of the flexible wiring substrate. Consequently, static electricity that enters the interior of the display apparatus does not jump to the free end of the flexible wiring substrate, but rather is grounded after flowing from the distal end of the rib to the surface of the rear member through the opening of the support member. As a result, it is possible to minimize the occurrence of static electricity that enters the interior of the display apparatus jumping to the flexible wiring substrate.

For example, the display apparatus according to an aspect of the present invention may further include a backlight that is supported by the rear member and projects light onto the rear surface of the display panel.

With this configuration, the rear member can be used as a component for supporting the backlight.

### Advantageous Effects

The display apparatus according to an aspect of the present invention is capable of protecting the display panel from static electricity

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is external view of the display apparatus according to an embodiment,

FIG. 2 is an exploded perspective view of the display apparatus according to an embodiment.

FIG. 3 is a cross sectional view of relevant components of the display apparatus taken at the line A-A in FIG. 1.

FIG. 4 is a cross sectional view of relevant components of the display apparatus taken at the line B-B in FIG, 1.

FIG. 5 is an enlarged, perspective cross sectional view of relevant components of the display apparatus illustrating openings provided in the molded frame.

FIG. 6 is a cross sectional view of relevant components of a conventional display apparatus.

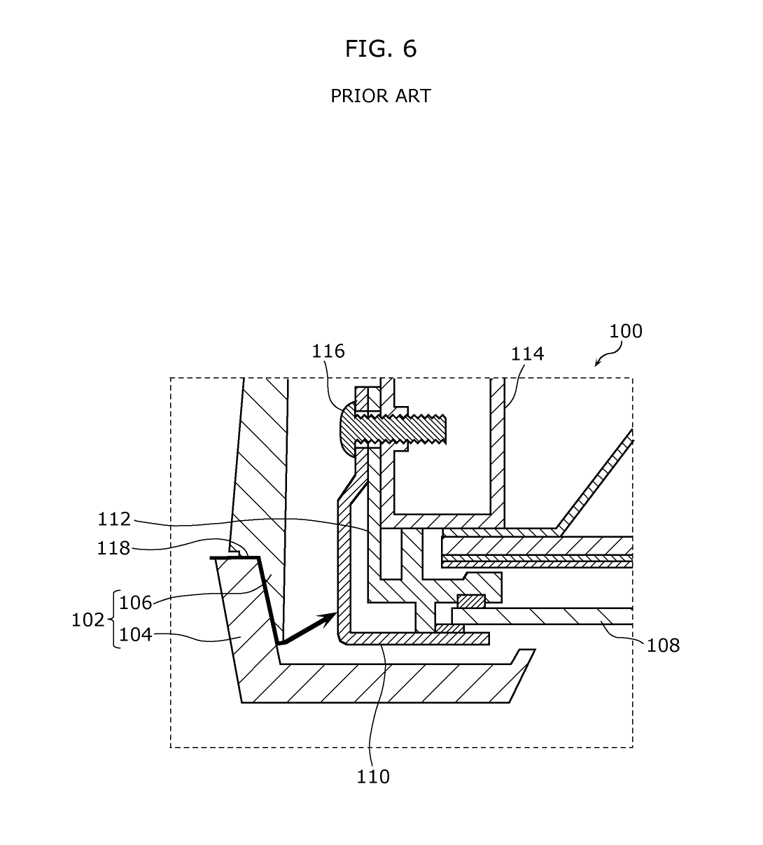

### DESCRIPTION OF EMBODIMENTS

Hereinafter, an illustrative embodiment is described in greater detail with reference to the accompanying Drawings. It should be noted that the illustrative embodiment described below shows a specific example of the present invention. The numerical values, shapes, materials, structural elements, and the arrangement and connection of the structural elements etc. shown in the following illustrative embodiment are mere examples, and therefore do not limit the present invention, the scope of which is defined in the appended Claims. Therefore, among the structural elements in the following illustrative embodiment, structural elements not recited in any one of the independent claims are described as preferred structural elements, and are not absolutely necessary to overcome the problem according to the present invention.

### Embodiment

### [General Structure of the Display Apparatus]

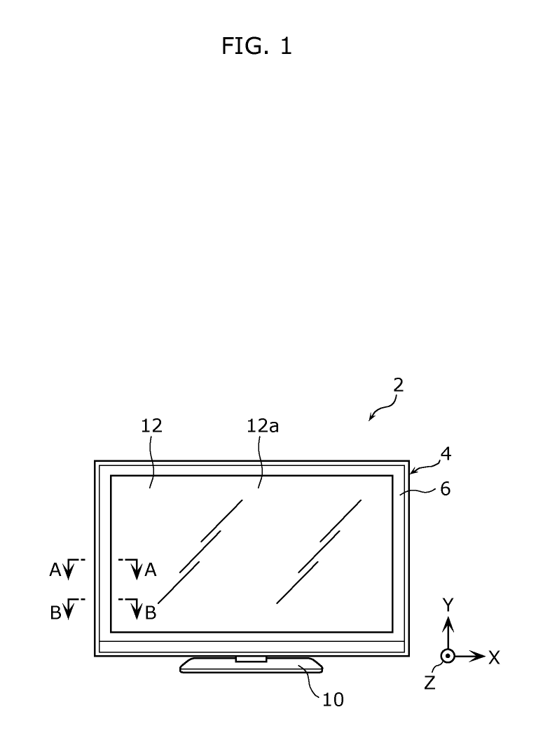

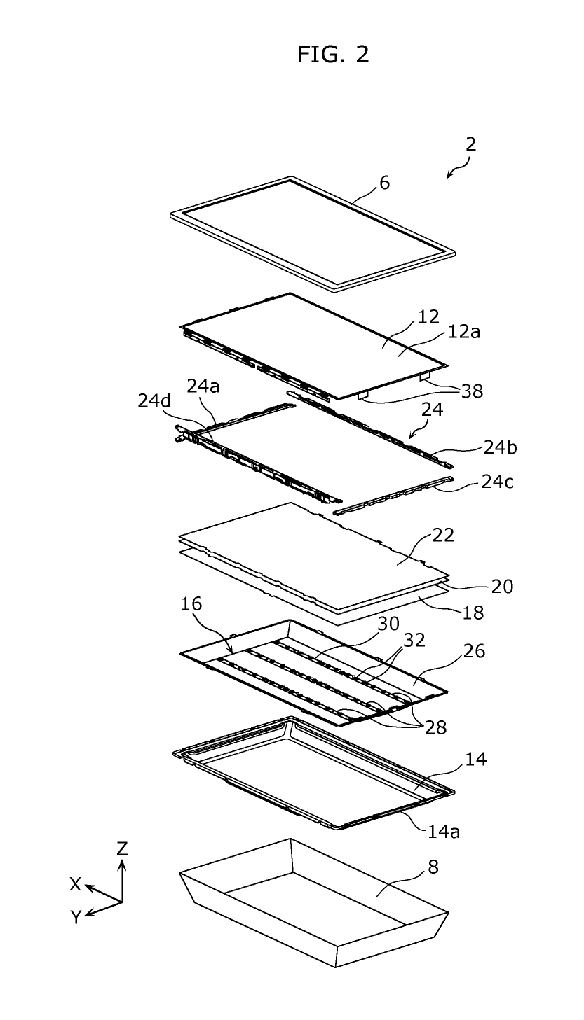

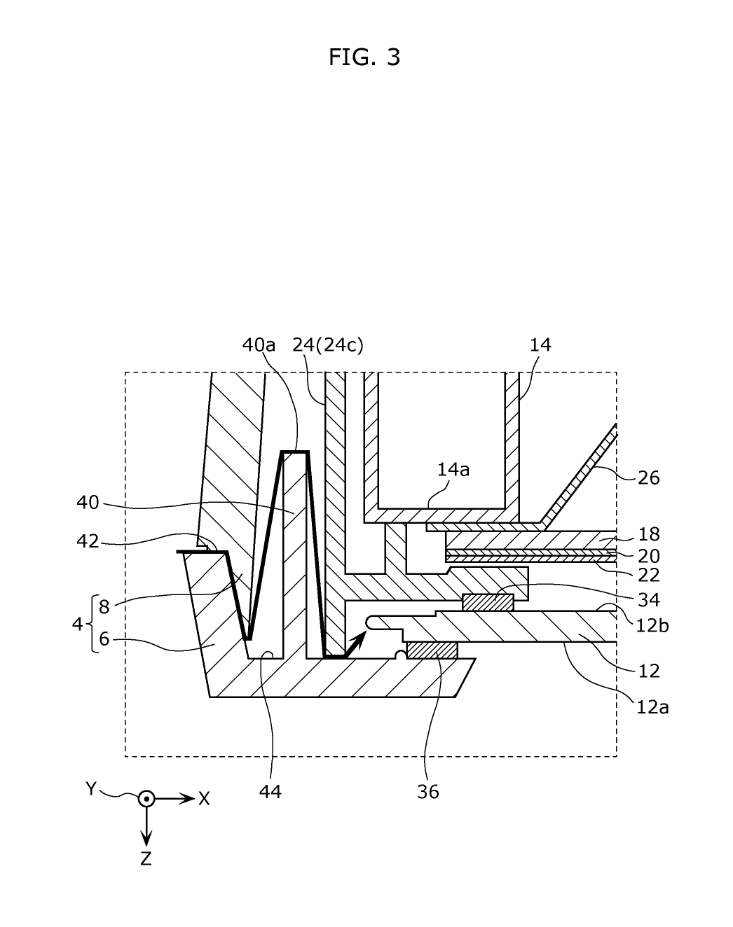

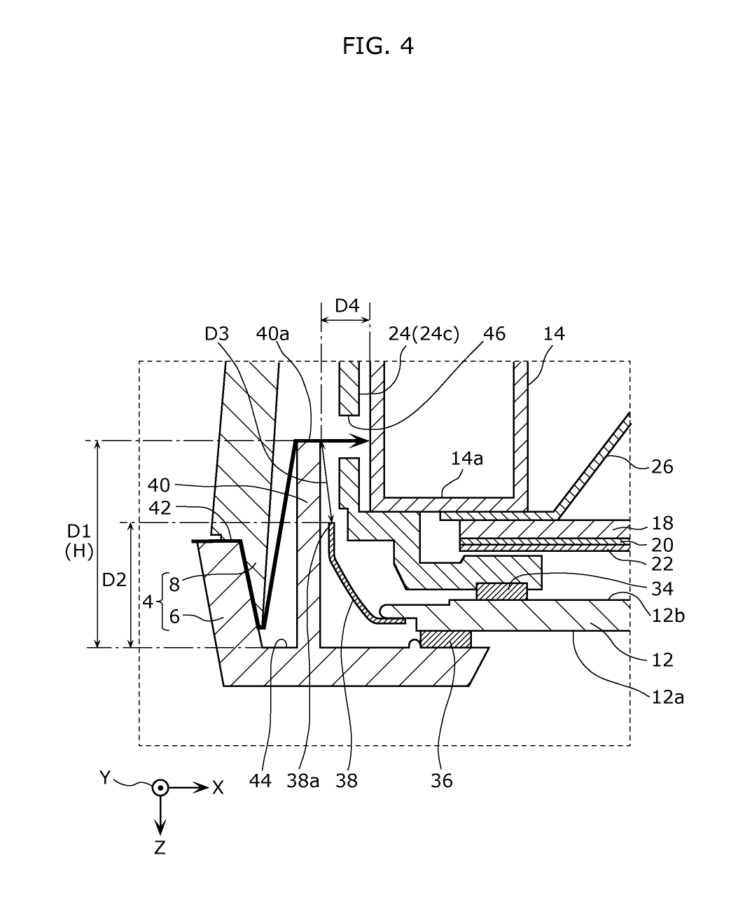

First, with reference to FIG, 1 through FIG. 4, the general structure of the display apparatus according to the embodiment will be described. FIG. 1 is external view of the display apparatus according to the embodiment. FIG. 2 is an exploded perspective view of the display apparatus according to the embodiment. FIG. 3 is a cross sectional view of relevant components of the display apparatus taken at the line A-A in FIG. 1, FIG. 4 is a cross sectional view of relevant components of the display apparatus taken at the line B-B in FIG. 1.

As illustrated in FIG. 1 and FIG. 2, the display apparatus 2 according to the embodiment is, for example, a liquid crystal television receiver. The display apparatus 2 includes a casing 4 for housing various components. The casing 4 is configured of a front cabinet 6 (the front casing) and a rear cabinet 8 (the rear casing) interconnected together. Note that a stand 10 for supporting the casing 4 from below is attached to the bottom end portion of the casing 4.

The front cabinet 6 is a rectangular frame-like component disposed to cover the periphery of a front surface 12a of a liquid crystal panel 12 (the display panel), which will be described later. The front cabinet 6 is, for example, made of resin.

The rear cabinet 8 slightly bulges out away from the display apparatus 2 and is disposed to cover the entire rear surface 12b of the liquid crystal panel 12. The rear cabinet 8 is interconnected with the front cabinet 6 around the perimeter of the liquid crystal panel 12. The rear cabinet 8 is, for example, made of resin.

As illustrated in FIG, 2, a rear frame 14 (the rear member), a backlight unit 16, a diffuser panel 18, a pair of optical sheets 20 and 22, a molded frame 24 (the support member), and the liquid crystal panel 12 are disposed between the front cabinet 6 and the rear cabinet 8. Note that the display apparatus 2 according to the embodiment does not include the bezel described in the Background section of the present disclosure.

The rear frame 14 is disposed to cover the entire inner surface of the rear cabinet 8, The periphery of the rear frame 14 includes a flange 14a. The rear frame 14 is made from sheet metal such as steel, electrically chromate coated (SECC). The rear frame 14 is, for example, fastened to a ground wire of a wiring substrate (not shown in the drawings) with a screw (not shown in the drawings) to establish a conductive connection (ground) between the rear frame 14 and the ground wire of the wiring substrate.

The backlight unit 16 is, for example, a direct back-lit backlight unit for projecting light onto the rear surface 12b of the liquid crystal panel 12. The backlight unit 16 includes a reflective sheet 26 and light emitting diode (LED) bars 28.

The reflective sheet 26 is disposed to cover the entire inner surface of the rear frame 14. The reflective sheet 26 reflects light from the LED bars 28 toward the rear surface 12b of the liquid crystal panel 12. The reflective sheet 26 is made of, for example, acrylic resin,

Each LED bar 28 has an elongated shape. The LED bars 28 are disposed spaced apart from and substantially parallel to each other. Each LED bar 28 includes a wiring substrate 30 and a plurality of LEDs 32 mounted on the wiring substrate 30.

The wiring substrate 30 has an elongated plate-like shape. The wiring substrate 30 is made from a metal having high thermal conductivity, such as aluminum. The wiring substrate 30 is disposed on the reflective sheet 26.

The LEDs 32 are arranged in a single row in the lengthwise direction of the wiring substrate 30, and are spaced apart from each other. Each LED 32 is, for example, a powered LED.

The diffuser panel 18 is a thin rectangular plate-like component disposed between the backlight unit 16 and the liquid crystal panel 12, The diffuser panel 18 diffuses light from the backlight unit 16 toward the rear surface 12b of the liquid crystal panel 12.

The optical sheets 20 and 22 are stacked together and disposed to cover the surface of the diffuser panel 18. The optical sheets 20 and 22 are each, for example, for guiding light diffused by the diffuser panel 18 to the rear surface 12b of the liquid crystal panel 12.

Note that, as illustrated in FIG. 3, the periphery of each of the reflective sheet 26, the diffuser panel 18, and the pair of optical sheets 20 and 22 is supported by the flange 14a of the rear frame 14.

The molded frame 24 is configured of four elongated frame components 24a through 24d assembled together in a rectangular frame-like shape. The molded frame 24 is attached to the flange 14a of the rear frame 14. The molded frame 24 is, for example, made of resin.

The liquid crystal panel 12 is a rectangular panel. As illustrated in FIG. 3, the periphery of the rear surface 12b of the liquid crystal panel 12 is supported by the molded frame 24 via a cushion 34, Moreover, the periphery of the front surface 12a of the liquid crystal panel 12 is supported by the front cabinet 6 via a cushion 36. With this, the periphery of the liquid crystal panel 12 is fixed in place between the front cabinet 6 and the molded frame 24. Note that the cushions 34 and 36 are each for absorbing any impact that the liquid crystal panel 12 may receive, and are made of, for example, urethane. An image is displayed in the display region of the front surface 12a of the liquid crystal panel 12 as a result of light from the backlight unit 16 projecting on the rear surface 12b of the liquid crystal panel 12.

As illustrated in FIG, 2 and FIG, 4, a pair of chip-on-film (COF) structures 38 (the flexible wiring substrates) is provided on the short sides of the periphery of the liquid crystal panel 12. The pair of COF structures 38 each extend from the periphery of the liquid crystal panel 12 toward the rear cabinet 8. An integrated circuit (IC) (not shown in the drawings) for controlling driving of the liquid crystal panel 12 is mounted in each COF structure 38. It should be noted that the free end 38a of each COF structure 38 is not fixed to anything.

### [Static Electricity Protective Structure]

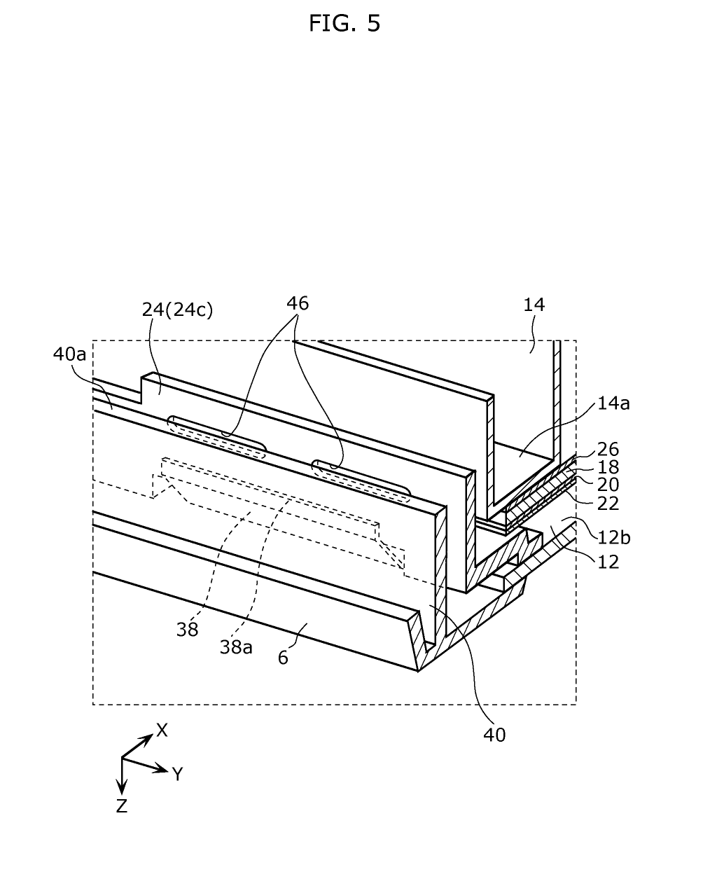

Next, the static electricity protective structure for protecting the liquid crystal panel 12 from static electricity, which is a characteristic structure of the display apparatus 2 according to the embodiment, will be described with reference to FIG. 3, FIG. 4, and FIG. 5. FIG. 5 is an enlarged, perspective cross sectional view of relevant components of the display apparatus illustrating openings provided in the molded frame. Note that for the purpose of illustration, the rear cabinet 8 is omitted in FIG. 5.

As illustrated in FIG. 3 through FIG. 5, the inner surface (base surface 44 (to be described later)) of the front cabinet 6 includes a rib 40 that extends toward the rear cabinet 8. The rib 40 is disposed in a space between (i) a mating surface 42 between the front cabinet 6 and the rear cabinet 8 and (ii) the periphery of the liquid crystal panel 12, and provided along the entire perimeter of the front cabinet 6. The rib 40 extends toward the rear cabinet 8 such that the distal end 40a thereof is disposed beyond the mating surface 42, The height H of the rib 40 measured from the inner surface of the front cabinet 6 is set such that the creepage distance from the mating surface 42 to the periphery of the liquid crystal panel 12 (in other words, the distance of the path indicated by the arrow in FIG. 3) is 20 mm or greater, Here, creepage distance is, when electricity is discharged to a target, the shortest discharge path from a discharge source to the target. Note that the height H of the rib 40 is substantially constant along the entire perimeter of the front cabinet 6.

As illustrated in FIG. 4 and FIG. 5, the molded frame 24 (the frame component 24c) has two pairs of openings 46. Each pair of the openings 46 is arranged in the molded frame 24 so as to correspond to one of the COF structures 38, and arranged in the molded frame 24 so as to be in the vicinity of the distal end 40a of the rib 40. Each opening 46 is an elongated hole that extends along the lengthwise direction of the rib 40 (Y axis direction). The surface of the rear frame 14 is exposed to the distal end 40a of the rib 40 through these openings 46.

Note that, as illustrated in FIG, 4, the distance D1 from the base surface 44 of the front cabinet 6 (that is, the inner surface of the front cabinet 6) to the distal end 40a of the rib 40 is designed to be greater than the distance D2 from the base surface 44 to the free end 38a of the COF structure 38. Moreover, the distance D3 from the distal end 40a of the rib 40 to the free end 38a of the COF structure 38 is designed to be greater than the distance D4 from the distal end 40a of the rib 40 to the surface of the rear frame 14,

### [Advantageous Effect]

Next, the advantageous effects of the display apparatus 2 according to the embodiment will be described. There is slight gap at the mating surface 42 between the front cabinet 6 and the rear cabinet 8. Consequently, when, for example, an electrically charged user touches the casing 4 with, for example, his or her hand, static electricity may travel through this gap into the interior of casing 4, as indicated by the arrows in FIG. 3 and FIG. 4.

With the display apparatus 2 according to the embodiment, since, as described above, the front cabinet 6 includes the rib 40, the creepage distance from the mating surface 42 to the periphery of the liquid crystal panel 12 can be increased. With this, even when the bezel described in the Background section of the present disclosure is omitted to reduce the size of the frame of the display apparatus 2, it is possible to minimize the occurrence of static electricity that enters the interior of the casing 4 jumping to the liquid crystal panel 12 and protect the liquid crystal panel 12 from static electricity,

It is generally stated that insulation can be maintained for a voltage of 1 kV with a creepage distance of 1 mm. As such, for static electricity of, for example, 20 kV, by setting the height H of the rib 40 such that the creepage distance from the mating surface 42 to the periphery of the liquid crystal panel 12 is 20 mm or more, it is possible to minimize the occurrence of static electricity that enters the interior of the casing 4 jumping to the liquid crystal panel 12 even more effectively.

Moreover, the creepage distance from the mating surface 42 to the free end 38a of the COF structure 38 is comparatively shorter at portions of the periphery of the liquid crystal panel 12 where the COF structures 38 are located. As such, with the display apparatus 2 according to the embodiment, as described above, a pair of the openings 46 is arranged in the molded frame 24 so as to correspond to one of the COF structures 38. Furthermore, the distance D1 from the base surface 44 of the front cabinet 6 to the distal end 40a of the rib 40 is greater than the distance D2 from the base surface 44 to the free end 38a of the COF structure 38, and the distance D3 from the distal end 40a of the rib 40 to the free end 38a of the COF structure 38 is greater than the distance D4 from the distal end 40a of the rib 40 to the surface of the rear frame 14, With this, the creepage distance from the mating surface 42 to the surface of the rear frame 14 is shorter than the creepage distance from the mating surface 42 to the free end 38a of the COF structure 38. As a result, static electricity that enters the interior of the casing 4 does not jump to the free end 38a of the COF structure 38, but rather is grounded after flowing from the distal end 40a of the rib 40 to the surface of the rear frame 14 through the pair of openings 46. With this, it is possible to minimize the occurrence of static electricity that enters the interior of the casing 4 jumping to the COF structure 38.

Furthermore, by providing the front cabinet 6 with the rib 40, the rigidity of the front cabinet 6 can be increased.

The display apparatus has hereinbefore been described according to an embodiment of the present invention, but the present invention is not limited to this embodiment,

In the above embodiment, the display apparatus is exemplified as a liquid crystal television receiver, but the display apparatus is not limited to this example; the display apparatus may be, for example, a liquid crystal monitor for a computer,

In the above embodiment, the flexible wiring substrate is exemplified as a COF structure, but the flexible wiring substrate is not limited to this example; the flexible wiring substrate may be, for example, a flexible flat cable in which an IC chip is not mounted.

In the above embodiment, the opening provided in the molded frame is exemplified as an elongated hole, but the opening is not limited to this example; the opening may be, for example, a circular hole or any given shape. Alternatively, the opening may be formed as a cutout (notch) instead of a hole.

In the above embodiment, the openings of the molded frame are arranged to correspond to the COF structures, but the openings may be arranged to correspond to other locations other than the locations in which the COF structures are disposed.

In the above embodiment, a bezel for supporting the periphery of the front surface of the liquid crystal panel is omitted, but it goes without saying that a bezel may be provided.

In the above embodiment, the rib is provided along the entire perimeter of the front cabinet, but the rib is not limited to this example; the rib may, for example, be provided only on a portion of the front cabinet (for example, only on the short sides of the front cabinet).

In the above embodiment, the height of the rib is exemplified as being substantially constant along the entire perimeter of the front cabinet, but the height of the rib is not limited to this example; the height of the rib may, for example, vary along the entire perimeter of the front cabinet.

In the above embodiment, the rib is exemplified as extending toward the rear cabinet such that the distal end thereof is disposed beyond the mating surface, but the rib is not limited to this example; the rib may extend toward the rear cabinet such that the rib terminates before the mating surface, and alternatively the rib may be designed to have any given height.

In the above embodiment, the backlight unit is exemplified as a direct back-lit backlight unit, but the backlight unit is not limited to this example; the backlight unit may be an edge-lit backlight unit.

In the above embodiment, the molded frame is exemplified as being separable into four frame components, but the molded frame is not limited to this example; the molded frame may be a single component.

### INDUSTRIAL APPLICABILITY

The display apparatus according to the present invention is applicable as, for example, a liquid crystal television receiver.

1. A display apparatus for displaying an image, the display apparatus comprising:
a display panel that displays the image;
a frame that covers a periphery of a front surface of the display panel;
a rear casing that covers a rear surface of the display panel and is engaged with the frame at a mating surface; and
a rib disposed in a space between the mating surface and a periphery of the display panel and extending from the frame toward the rear casing.

2. The display apparatus according to claim 1,
wherein the rib is provided along an entire perimeter of the frame.

3. The display apparatus according to claim 1,
wherein the rib extends from a base surface of the frame toward the rear casing, and
a distance from the base surface to a distal end of the rib is greater than a distance from the base surface to the mating surface.

4. The display apparatus according to claim 1, further comprising:
a support member that supports a periphery of the rear surface of the display panel; and
a rear member made of metal and disposed between the display panel and the rear casing,
wherein the support member has an opening that exposes a surface of the rear member to a distal end of the rib.

5. The display apparatus according to claim 4, further comprising
a flexible wiring substrate disposed on the periphery of the display panel,
wherein the opening is arranged corresponding to the flexible wiring substrate.

6. The display apparatus according to claim 5,
wherein the rib extends from a base surface of the frame toward the rear casing, and
a distance from the base surface to the distal end of the rib is greater than a distance from the base surface to a free end of the flexible wiring substrate, and a distance from the distal end of the rib to the free end of the flexible wiring substrate is greater than a distance from the distal end of the rib to the rear member.

7. The display apparatus according to claim 4, further comprising
a backlight that is supported by the rear member and projects light onto the rear surface of the display panel.
